(19) United States
(12) Patent Application Publication
(10) Pub. No.: US 2019/0176464 A1
(43) Pub. Date: Jun. 13, 2019

(54) INK JET PRINTING METHOD AND INK JET PRINTING APPARATUS

(71) Applicant: CANON KABUSHIKI KAISHA, Tokyo (JP)

(72) Inventor: Toru Ohnishi, Yokohama-shi (JP)

(21) Appl. No.: 16/212,343

(22) Filed: Dec. 6, 2018

(30) Foreign Application Priority Data
Dec. 11, 2017 (JP) 2017-237043

(51) Int. Cl. B41J 2/005

(52) U.S. Cl. CPC B41J 2/0057

(57) ABSTRACT

An ink jet printing method includes forming a pattern adapted to estimate transferability by applying an ink and an auxiliary liquid onto an image forming surface of a transfer member, and transferring the pattern onto a printing medium. The pattern includes a plurality of unit images, each including an estimation ink image formed with the ink and having an auxiliary liquid-applied region including the estimation ink image. The unit images vary in amount of the auxiliary liquid applied for the estimation ink image for estimation.

### BACKGROUND OF THE INVENTION

### Field of the Invention

The present disclosure relates to an ink jet printing method and an ink jet printing apparatus.

### Description of the Related Art

In an ink jet printing method, imagery is formed by directly or indirectly applying a liquid composition (ink) containing a coloring material onto a printing medium, such as a paper medium. At this time, the printing medium may absorb an excessive amount of liquid from the liquid composition, causing curling or cockling in some cases.

A transfer ink jet printing method is known as a method that can prevent curling or cockling. In this transfer ink jet method, imagery formed on a transfer member is transferred onto a printing medium, such as a paper sheet, after liquid has been removed from the imagery on the transfer member by thermal energy or the like.

Unfortunately, in such a transfer ink jet printing method, the surface of the transfer member is likely to be affected by, for example, the pressure repeatedly applied thereto and may result in changes in surface properties. This may distort imagery or causes transfer failure. Accordingly, it is desirable to replace or restore the transfer member at regular intervals and to determine the interval appropriately. Excessive delay of the replacement or restoration of the transfer member increases the possibility of producing an image-formed article having a poor-quality image, and, in contrast, unnecessarily early replacement or restoration is disadvantageous in productivity and cost.

Japanese Patent Laid-Open No. 2010-260237 discloses a method of appropriately determining when the transfer member should be replaced depending on the surface condition of the transfer member estimated by measuring the contact angle of a droplet on the surface of the transfer member.

While changes in surface condition can be estimated by the measurement of the contact angle disclosed in Japanese Patent Laid-Open No. 2010-260237, this method does not always detect decrease in transfer performance and transfer failure resulting from a decreased thickness of the transfer member caused by a pressure repeatedly placed on the transfer member.

### SUMMARY OF THE INVENTION

Accordingly, the present disclosure provides an ink jet printing method and apparatus in which the transferability of imagery can be estimated for effective use of the transfer member.

The ink jet printing method includes forming a primary image by applying an ink onto an image forming surface of a transfer member; forming a secondary image by applying an auxiliary liquid containing a thermoplastic resin onto the primary image on the transfer member; and transferring the secondary image on the transfer member onto a printing medium by bringing the secondary image into contact with the printing medium and then removing the secondary image from the transfer member in a state where the secondary image is kept in contact with the printing medium.

The secondary image includes a pattern adapted to estimate transferability. The pattern includes a plurality of unit images. Each unit image includes an estimation ink image formed with the ink and has an auxiliary liquid-applied region including the estimation ink image. The unit images vary in amount of the auxiliary liquid applied for the estimation ink image for estimation.

Further features of the present disclosure will become apparent from the following description of exemplary embodiments with reference to the attached drawings.

### BRIEF DESCRIPTION OF THE DRAWINGS

FIG. 1 is a schematic diagram illustrating an ink jet printing apparatus according to an embodiment of the present disclosure.

FIG. 2 is a block diagram of an overall control system of the ink jet printing apparatus shown in FIG. 1.

FIG. 3 is a block diagram of a printer control unit of the ink jet printing apparatus shown in FIG. 1.

FIG. 4 is a schematic diagram illustrating an ink jet printing apparatus according to an embodiment of the present disclosure.

FIGS. 5A and 5B are each a flow diagram of a process for forming a transferability estimation pattern.

FIG. 6 is an illustrative representation of an exemplary transferability estimation pattern.

FIGS. 7A and 7B are each an illustrative representation of a unit image of a transferability estimation pattern.

### DESCRIPTION OF THE EMBODIMENTS

In the ink jet printing method of the present disclosure, a printed article is produced by transferring a secondary image formed by applying an auxiliary liquid onto a primary image formed by applying an ink onto a transfer member onto a printing medium. The ink jet printing method includes forming a transferability estimation pattern on a transfer member and transferring the transferability estimation pattern onto a printing medium. The degree of transfer performance is checked through these steps.

The ink jet printing apparatus of the present disclosure includes an image forming unit operable to apply an ink onto a transfer member to form a primary image, an auxiliary liquid application device operable to apply an auxiliary liquid onto the primary image on the transfer member to form a secondary image, and a transfer unit operable to transfer the secondary image onto a printing medium. The ink jet printing apparatus also includes a control unit operable for instruction to form a transferability estimation pattern and to transfer the pattern onto the printing medium.

The transferability estimation pattern mentioned herein includes a plurality of transferability estimation images (hereinafter referred to as unit images) used for estimating the transferability of the image on the transfer member from the transfer member to a printing medium.

The transferability estimation pattern includes an estimation ink image formed with an ink and has an auxiliary liquid-applied region including the estimation ink image. The transferability estimation pattern has a plurality of unit images varying in amount of auxiliary liquid applied for the estimation ink image for estimation.

The conditions of the transfer member and the transfer unit can be estimated from the states of the transferred unit images of the transferability estimation pattern. Thus, it can be estimated, for example, when the transfer medium should be replaced or when the transfer unit should be maintained.

The ink jet printing method and apparatus according to an embodiment of the present disclosure will now be described.

The ink jet printing apparatus disclosed herein may be operable to eject an ink onto a transfer member to form an ink image that is a primary image, remove liquid from the ink image with a liquid removal device, and then transfer the ink image onto a printing medium. This type of ink jet printing apparatus is hereinafter expediently referred to as a transfer ink jet printing apparatus.

The transfer ink jet printing apparatus includes an image forming unit operable to form the primary image. The image forming unit includes an ink application device operable to apply an ink to the transfer member. The image forming unit may further include a reaction liquid application device in addition to the ink application device.

The transfer ink jet printing apparatus of the present disclosure also includes an auxiliary liquid application device operable to apply the auxiliary liquid to the primary image to form a secondary image, and a liquid removal device may be located at a position where liquid is removed from the secondary image on the transfer member.

A transfer ink jet printing apparatus will now be described.

### Transfer Ink Jet Printing Apparatus

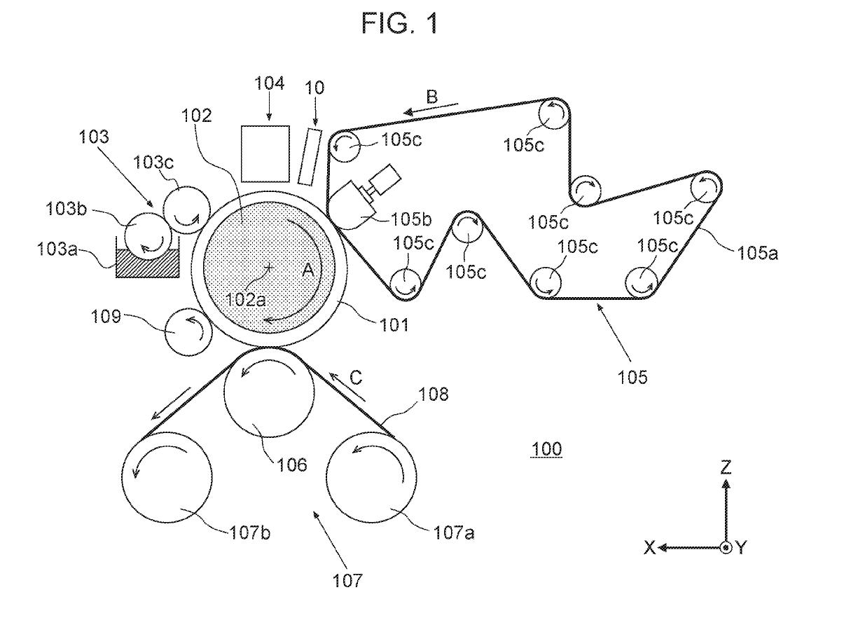

FIG. 1 is a schematic diagram illustrating the structure of a transfer ink jet printing apparatus 100 according to an embodiment of the present disclosure. The printing apparatus is a transfer ink jet printing apparatus intended for printing on extra-long printing media, and in which printed articles are produced by transferring ink images onto a printing medium 108 via a transfer member 101. In FIG. 1, the X, Y, and Z directions represent the total length direction, the depth direction (width direction), and the height direction, respectively, of the transfer ink jet printing apparatus 100. The printing medium 108 is conveyed in the X direction.

The transfer ink jet printing apparatus 100 includes a transfer member 101 supported on a support member 102, a reaction liquid application device 103, an ink application device 104 including an ink jet head, an auxiliary liquid application device 10, a liquid removal device 105, and a pressing member 106.

The reaction liquid application device 103 applies a reaction liquid onto the transfer member 101, and the reaction liquid contains a constituent capable of increasing the viscosity of the ink for forming ink images. The ink application device 104 applies an ink onto the transfer member 101 onto which the reaction liquid has been applied to form an ink image that is a primary image. The auxiliary liquid application device 10 applies an auxiliary liquid capable of facilitating transfer onto the primary image on the transfer member 101, thus forming a secondary image. The secondary image is treated by the liquid removal apparatus 105 operable to remove liquid from the ink image or secondary image. The secondary image from which liquid has been removed is transferred onto a recoding medium 108, such as a paper medium, by the operation of the pressing member 106.

The ink image is formed and treated on an image forming surface (not shown) of the transfer member 101.

In the embodiment disclosed herein, the image forming unit includes the reaction liquid application device 103 and the ink application device 104. The transfer unit includes the transfer member 101, the support member 102 for the transfer member, and the pressing member 106 for transfer.

A transferability estimation pattern is formed on the transfer member 101 by the image forming unit and the auxiliary liquid application device 10 according to an instruction from a control unit (not shown) and then transferred onto the printing medium 108 by the transfer unit.

By transferring (printing) the transferability estimation pattern onto the printing medium, the condition of the transfer member and the operational condition of the transfer unit can be checked.

The transferability estimation pattern may be formed in a space that is a region other than the region used as the printed article or on a printing medium exclusive to transferability estimation use.

The degree of transfer performance can be determined from the transferability estimation pattern formed on the printing medium, thus estimating when the transfer member should be replaced or when the transfer unit should be maintained to prevent a decrease in transferability and transfer failure. Thus, printed articles are continuously produced without reducing productivity.

The transfer ink jet printing apparatus 100 may include a transfer member cleaning member 109 operable to clean the surface of the transfer member 101, if necessary. The transfer member 101, the reaction liquid application device 103, the liquid removal device 105, and the transfer member cleaning member 109 each have a dimension in the Y direction that corresponds to the width of the printing medium 108. Also, the ink jet head of the ink application device 104 and the ink jet head of the auxiliary liquid application device 10 each have a dimension in the Y direction that corresponds to the width of the printing medium 108.

The transfer member 101 rotates in the direction indicated by arrow A shown in FIG. 1 about a rotational axis 102a of the support member 102. The rotation of the support member 102 moves the surface of the transfer member 101. The reaction liquid application device 103 and the ink application device 104 apply the reaction liquid and the ink in this order onto the moving image forming surface of the transfer member 101, thus forming an ink image on the transfer member 101. Furthermore, the auxiliary liquid application device 10 applies the auxiliary liquid onto the ink image. The ink image onto which the auxiliary liquid has been applied is conveyed to a position where the ink image comes into contact with a liquid absorption member 105a of the liquid removal device 105 by the movement of the image forming surface of the transfer member 101.

The image forming surface of the transfer member 101 and the liquid absorption member 105a of the liquid removal device 105 are moved in synchronization with the rotation of the transfer member 101. The ink image on the transfer member 101 comes into contact with the moving liquid absorption member 105a. The liquid absorption member 105a in contact with the ink image removes liquid from the ink image including the auxiliary liquid. In some embodiments, the liquid absorption member 105a in contact with the ink image may be pressed against the transfer member 101 at a predetermined pressure in view of effective operation of the liquid absorption member 105a.

From a different perspective, this removal of liquid can be referred to as the concentration of the ink forming the ink image on the transfer member. The concentration of the ink implies that the content of solids including the coloring material and a resin in the ink is increased with respect to the liquid content by reducing the liquid content in the ink.

The ink image from which liquid has been removed becomes thicker than the ink image before the liquid removal, and this thicker ink image on the transfer member 101 is further conveyed to a position where the ink image comes into contact with the printing medium 108 by a printing medium conveying device 107. When the ink image after the liquid removal is in contact with the printing medium 108, the pressing member 106 presses the transfer member 101 to transfer the ink image onto the printing medium 108. The ink image transferred onto the printing medium 108 is an image reverse to the ink image before and after the liquid removal.

In the embodiment disclosed herein, the ink image is formed by applying an ink onto the transfer member onto which a reaction liquid has been applied; hence, the reaction liquid applied to the region (non-image region) where the ink image is not formed remains without reacting with the ink. In the apparatus disclosed herein, the liquid absorption member 105a removes liquid not only from the ink image but also from the unreacted reaction liquid.

Furthermore, if the auxiliary liquid contains a liquid, such as water, the liquid absorption member 105a remove the liquid from the auxiliary liquid applied to the non-image region as well as the reaction liquid.

Hence, the expression for “removing liquid from the ink image” or similar expression does not definitely mean that liquid is removed from only the ink image, but means that liquid is removed from at least the ink image on the transfer member.

The liquid to be removed is not limited to a specific substance provided that it is a shapeless substance that flows and has a volume. For example, the liquid includes the water, the organic solvent, and the like contained in the ink, the reaction liquid, and the auxiliary liquid.

Major components and members of the transfer ink jet printing apparatus of the present embodiment will now be described.

### Transfer Member

The transfer member 101 includes a surface layer having the image forming surface. The surface layer may be made of a resin, a ceramic, or any other suitable material. In at least some embodiments, a material having a high compressive modulus may be used from a viewpoint of durability. Examples of such a material include acrylic resin, acrylic silicone resin, fluororesin, condensates of a hydrolyzable group-containing silicon compound. The transfer member may be subjected to surface treatment to increase wettability of the reaction liquid and transferability of the image. Examples of such surface treatment include frame treatment, corona treatment, plasma treatment, grinding, roughening, active energy irradiation, ozonation, surfactant treatment, and silane coupling. These treatments may be combined. The surface layer may have a relief pattern in the surface.

The transfer member may have a compression layer functioning to absorb fluctuations in pressure on the side of the surface layer adjacent to the support member. The compression layer absorbs deformation and disperses local fluctuations in pressure, thus maintaining transfer performance good even during high-speed printing. The compression layer may be made of, for example, acrylonitrile-butadiene rubber, acrylic rubber, chloroprene rubber, urethane rubber, or silicone rubber. In at least some embodiments, the compression layer may be porous, and the porous layer may be formed of a rubber material containing a predetermined amount of a vulcanizing agent, a vulcanization accelerator, or the like and, optionally, a foaming agent and a filler, such as fine hollow particles or salt. Since the air in the porous compression layer is compressed to change the volume by fluctuating pressure, the deformation of the porous compression layer is not much deformed in any direction except the compressing direction, thus contributing to stable transfer performance and durability. The porous rubber material may have a structure in which pores range continuously or a structure in which pores are separate from and independent of each other. In the present embodiment, the porous rubber may have either structure or may be in a combination of these structures.

The transfer member may further include an elastic layer between the surface layer and the compression layer. The elastic layer may be made of a resin, a ceramic, or any other suitable material. In an embodiment, an elastomer or a rubber may be used from the viewpoint of workability. Examples of such a material include silicone rubber, fluorosilicone rubber, phenyl silicone rubber, fluorocarbon rubber, chloroprene rubber, urethane rubber, nitrile rubber, ethylene propylene rubber, natural rubber, styrene rubber, isoprene rubber, butadiene rubber, ethylene-propylene-butadiene copolymer, and nitrile butadiene rubber. Silicon rubber, fluorosilicone rubber, and phenyl silicone rubber have a low compression set and are accordingly stable in dimensions and durability. These rubbers also exhibit slight changes in modulus of elasticity with temperature. This is beneficial in terms of transfer performance.

The surface layer, the elastic layer, and the compression layer of the transfer member may be secured to each other with an adhesive or a double-sided adhesive tape disposed therebetween. The transfer member may further include a reinforcing layer having a high compressive modulus to reduce transverse elongation when the transfer member is mounted in the apparatus and to maintain the toughness. A woven fabric may be used as the reinforcing layer. The transfer member may be formed by combining the above-described layers as desired.

The size of the transfer member may be selected depending on the size of the images to be printed. The transfer member may have a shape of, but not limited to, a sheet, a roller, a belt, or an endless web.

### Support Member

The transfer member 101 is supported on the support member 102. An adhesive or a double-sided adhesive tape may be used for supporting the transfer member. The transfer member may be supported on the support member 102 with a securing member made of metal, ceramic, resin, or the like.

The support member 102 has a structural strength to some extent from the viewpoint of conveyance accuracy and durability. The support member 102 may be made of metal, ceramic, resin, or the like. Exemplary materials often used for the support member include aluminum, iron, stainless steel, acetal resin, epoxy resin, polyimide, polyethylene, polyethylene terephthalate, nylon, polyurethane, silica ceramics, and alumina ceramics. These materials are beneficial in terms of rigidity of the support member against pressure applied for transfer and dimensional accuracy and are also useful to reduce inertia during operation to improve control response. Two or more of these materials may be used in combination.

### Reaction Liquid Application Device

The transfer ink jet printing apparatus of the present embodiment also includes a reaction liquid application device 103 operable to apply a reaction liquid onto the transfer member 101. The reaction liquid application device 103 shown in FIG. 1 is a gravure offset roller system including a reaction liquid container 103a adapted to contain a reaction liquid, and reaction liquid application members 103b and 103c operable to apply the reaction liquid in the reaction liquid container 103a onto the transfer member 101.

The reaction liquid application device may have any structure provided that it can apply a reaction liquid onto the transfer member and may be arbitrarily selected from among the known devices having such a function. Examples of the reaction liquid application device include a gravure offset roller system, an ink jet head, a die coating device (die coater), and a blade coating device (blade coater). The reaction liquid application device may apply the reaction liquid before or after the application of the ink provided that the reaction liquid can be mixed (react) with the ink on the transfer member. In at least some embodiments, the reaction liquid is applied before the ink is applied. Applying the reaction liquid before applying the ink reduces bleeding and beading. Bleeding is a phenomenon where inks applied adjacently by an ink jet method for forming an image mingle with each other, and beading is a phenomenon where ink previously applied onto a surface is attracted to another ink subsequently applied.

### Reaction Liquid

The reaction liquid will come into contact with the ink to reduce the fluidity of the ink and/or one or some of the constituents of the ink composition on the transfer member, thus reducing ink bleeding and beading during image formation. More specifically, a reaction agent (constituent capable of increasing the viscosity of the ink) in the reaction liquid comes into contact with one or some of the constituents of the ink, such as a coloring material and a resin, and reacts with or absorbs the constituents. Thus, the viscosity of the ink is increased as a whole, or one or some constituents, such as the coloring material, form aggregates to locally increase the viscosity. Consequently, the fluidity of the ink and/or one or some of the constituents of the ink is reduced.

The reaction liquid may be a liquid that can aggregate particles of a constituent (resin, self-dispersible pigment, etc.) having an anionic group in the ink when coming into contact with the ink.

In at least some embodiments, the reaction liquid may contain a reaction agent that can aggregate particles of a constituent (resin, self-dispersible pigment, etc.) having an anionic group in the ink when coming into contact with the ink.

Examples of the reaction agent include multivalent metal ions, cationic components, such as cationic resin, and organic acids.

Exemplary multivalent metal ions include divalent metal ions, such as Ca²⁺, Cu²⁺, Ni²⁺, Mg²⁺, Sr²⁺, Ba²⁺, and Zn²⁺, and trivalent metal ions, such as Fe³⁺, Cr³⁺, Y³⁺ and Al³⁺. For adding a multivalent metal ion into the reaction liquid, a multivalent metal salt (or a hydrate thereof) formed by combining a multivalent metal ion and a counter anion may be used. Examples of such a counter anion include inorganic anions, such as Cl⁻, Br⁻, I⁻, ClO⁻, ClO₂⁻, ClO₃⁻, ClO₄⁻, NO₂⁻, NO₃⁻, SO₄²⁻, CO₃²⁻, HCO₃⁻, PO₄³⁻, HPO₄²⁻, and H₂PO₄⁻; and organic anions, such as HCOO⁻, (COO⁻)₂, COOH(COO₋), CH₃COO⁻, C₂H₄(COO⁻)₂, C₆H₅COO⁻, C₆H₄(COO⁻)₂, and CH₃SO₃⁻. If a multivalent metal ion is used as the reaction agent, the content thereof in terms of the multivalent metal salt may be in the range of 1.00% by mass to 10.00% by mass relative to the total mass of the reaction liquid.

If an organic acid is contained in the reaction liquid, the acid has a buffer capacity in an acid region (less than pH 7.0, beneficially pH 2.0 to 5.0) so as to convert the anionic group in the ink into an acid form for aggregation. Examples of the organic acid include monocarboxylic acids, such as formic acid, acetic acid, propionic acid, butyric acid, benzoic acid, glycolic acid, lactic acid, salicylic acid, pyrrole carboxylic acid, furan carboxylic acid, picolinic acid, nicotinic acid, thiophene carboxylic acid, levulinic acid, and coumaric acid, and salts thereof; dicarboxylic acids, such as oxalic acid, malonic acid, succinic acid, glutaric acid, adipic acid, maleic acid, formic acid, itaconic acid, sebacic acid, phthalic acid, malic acid, and tartaric acid, and salts and hydrogen salts thereof; tricarboxylic acids, such as citric acid and trimellitic acid, and salts and hydrogen salts thereof; and tetracarboxylic acids, such as pyromellitic acid, and salts and hydrogen salts thereof.

The cationic resin that may be used in the reaction agent may be a resin having a primary, secondary, or tertiary amine structure or a resin having a quaternary ammonium salt structure. Examples of the cationic resin include resins having a structure of vinyl amine, allyl amine, vinyl imidazole, vinyl pyridine, dimethylaminoethyl methacrylate, ethylene imine, or guanidine. The cationic resin may be combined with an acid compound or converted into a quaternary form so that the solubility of the cationic resin in the reaction liquid can be increased. If a cationic resin is used in the reaction agent, the content thereof in the reaction liquid may be in the range of 1.00% by mass to 10.00% by mass relative to the total mass of the reaction liquid.

Other constituents in the reaction liquid include the same constituents as those used in the ink, such as water, a water-soluble organic solvent, and additives. These constituents may be added each in a proportion similar to the proportion in the ink.

### Ink Application Device and Auxiliary Liquid Application Device

The transfer ink jet printing apparatus of the present embodiment also includes an ink application device 104 operable to apply an ink onto the transfer member 101 and an auxiliary liquid application device 10. An auxiliary liquid is applied onto the ink image formed with the reaction liquid and the ink on the transfer member. Furthermore, the liquid removal device 105 removes liquid from the ink image onto which the auxiliary liquid has been applied. Also, when at least either the reaction liquid or the auxiliary liquid is applied to the non-image region in which the ink image is not formed, the liquid removal device 105 removes liquid from either the liquids or a mixture of the liquids.

In the present embodiment, the ink application device operable to apply the ink and the auxiliary liquid operable to apply the auxiliary liquid each include an ink jet head operable to apply a liquid by an ink jet method. The ink jet head may be a type that ejects a liquid by film-boiling the liquid to form bubbles by electrothermal conversion, a type that ejects a liquid by electromechanical conversion, or a type that ejects a liquid by static electricity. In the embodiment disclosed herein, a known ink jet head may be used. In some embodiments, an electrothermal conversion type may be used from the viewpoint of high-speed, high-density printing. For image formation, on receiving image signals, each ink jet head applies an ink or the auxiliary liquid in a desired amount to an intended position.

In the embodiment disclosed herein, the ink jet heads are each a full-line head extending in the Y direction, and have ejection openings arranged over a region covering the width of the image printing region of the largest of the printing media to be used in the apparatus. The ink jet head has an ink ejection face at which ejection openings are open at the lower surface (adjacent to the transfer member 101), and the ink ejection face opposes the surface of the transfer member 101 with a very narrow gap (about several millimeters) therebetween.

The amount of ink or liquid applied may be represented by image density (duty) or the thickness of the applied ink. In the embodiment disclosed herein, the amount (g/m²) of liquid applied is defined by the average value obtained by dividing the product of the mass of each ink dot multiplied by the number of dots by the print area. The maximum amount of ink applied to an image region refers to the amount of ink applied to an area of at least 5 mm² or more in the region used as a piece of information of the transfer member from the viewpoint of removing liquid from the ink.

The ink application device 104 may include a plurality of ink jet heads to apply inks varying in color onto the transfer member. For example, for forming color patterns with respective inks of yellow, magenta, cyan, and black, the ink application device has four ink jet heads operable to eject the four inks respectively onto the transfer member, and the four ink jet heads are arranged in the X direction.

Also, the ink application device may include an ink jet head operable to eject a clear ink that contains no coloring material or a coloring material with a very low content and is therefore substantially transparent. The clear ink may be used for forming ink images in combination with the reaction liquid and the color inks. For example, the clear ink may be used to enhance the gloss of the image. In this instance, the amount of resin component added to the clear ink may be adjusted so that the resulting image can be glossy, and, further, the position where the clear ink is ejected may be controlled. Since it is beneficial that the clear ink is present closer than the color inks to the surface of the final printed article, the clear ink is applied onto the transfer member 101 earlier than the color inks. Accordingly, the ink jet head for the clear ink is disposed upstream from the ink jet heads for color inks in the direction in which the surface of the transfer member 101 opposing the ink application device 104 moves.

In an embodiment, another clear ink may be used for increasing the transferability of the image from the transfer member 101 to the recording medium in combination with the foregoing clear ink for enhancing gloss. For example, the clear ink for increasing transferability contains a constituent capable of increasing viscosity in a larger proportion than the color inks, and this clear ink is applied after the application of the color inks. In this instance, the ink jet head for the clear ink for increasing transferability is disposed downstream from the ink jet heads for color inks in the direction in which the surface of the transfer member 101 opposing the ink application device 104 moves. Thus, after the color inks are applied onto the transfer member 101, the clear ink for increasing transferability is applied onto the transfer member 101. The clear ink is thus present at the uppermost surface of the ink image. The clear ink at the surface of the ink image becomes sticky due to the combined use with the auxiliary liquid, sticking on the printing medium 108. Thus, the ink image after liquid removal is easy to remove to the printing medium 108 when transferred onto the printing medium with the transfer unit.

### Ink

Constituents of the ink used in the embodiment disclosed herein will now be described.

### Coloring Material

The ink may contain at least one of pigments and dyes as a coloring material. The coloring material content in the ink may be 0.5% by mass to 15.0% by mass. In at least some embodiments, it may be 1.0% by mass to 10.0% by mass.

The pigment used as the coloring material is not particularly limited. Examples of the pigment include inorganic pigment, such as carbon black and titanium oxide; and organic pigments, such as azo pigments, phthalocyanine pigments, quinacridone pigments, isoindolinone pigments, imidazolone pigments, diketopyrrolopyrrole pigments, and dioxazine pigments. These pigments may be used singly or in combination. The pigment is dispersed, and the dispersion may be made by any method without particular limitation. For example, the pigment may be a resin-dispersed pigment in which the pigment is dispersed with a resin dispersant, or a self-dispersible pigment whose particles have surfaces to which a hydrophilic group, such as an anionic group, is bound directly or indirectly with an atomic group therebetween. Two or more pigments dispersed in different manners may be used in combination.

The resin dispersant used for dispersing the pigment may be one of the known resin dispersants used in ink jet aqueous inks. In at least some embodiments, a water-soluble acrylic resin dispersant having a hydrophilic unit and a hydrophobic unit together in the molecule may be used. The resin may be a block copolymer, a random copolymer, a graft copolymer, or a combination of these copolymers.

The resin dispersant in the ink may be dissolved in the liquid medium, or particles of the resin dispersion may be dispersed in the liquid medium. A water-soluble resin mentioned herein implies that when the resin is neutralized with an alkali equivalent to the acid value of the resin, the resin does not form particles having a particle size that can be measured by dynamic light scattering.

The hydrophilic unit (unit having a hydrophilic group, such as an anionic group) can be formed by polymerizing, for example, a monomer having a hydrophilic group. Examples of the monomer having a hydrophilic group include acid monomers having an anionic group, such as (meth)acrylic acid and maleic acid, and anionic monomers, such as anhydrides or salts of those acid monomers. Examples of the counter cation of the salts of the acid monomers include lithium ion, sodium ion, potassium ion, ammonium ion, and organic ammonium ion.

The hydrophobic unit (unit having no hydrophilicity, unlike anionic groups or the like) can be formed by polymerizing, for example, a monomer having a hydrophobic group. Examples of the monomer having a hydrophobic group include monomers having an aromatic ring, such as styrene, α-methylstyrene and benzyl (meth)acrylate; and monomers having an aliphatic group ((meth)acrylic ester monomers), such as ethyl (meth)acrylate, methyl (meth)acrylate, and butyl (meth)acrylate.

The resin dispersant may have an acid value of 50 mg KOH/g to 550 mg KOH/g, for example, 100 mg KOH/g to 250 mg KOH/g. The weight average molecular weight of the resin dispersant may be 1,000 to 50,000. The ratio (pigment/resin dispersant) of the pigment content to the resin dispersion content may be in the range of 0.3 to 10.0 on a mass basis.

If a self-dispersible pigment is used, the self-dispersible pigment may be such that anionic groups, such as carboxy groups, sulfo groups, or phosphonate groups, are bound to the surface of the pigment particles directly or indirectly with an atomic group (—R—) therebetween. The anionic group may be in an acid form or a salt form. If the anionic group is in a salt form, a portion or the entirety of the salt may be dissociated. The counter ion, or cation, of the anionic group in the salt form may be an alkali metal ion, ammonium ion, or an organic ammonium ion. Also, examples of the atomic group (—R—) include linear or branched alkylene groups having a carbon number of 1 to 12, arylene groups, such as a phenylene group and a naphthylene group, an amide group, a sulfonyl group, an amino group, a carbonyl group, an ester group, and an ether group. The atomic group may be a combined form of these groups.

A dye may be used as the coloring material, and the dye is not particularly limited. In some embodiments, a dye having an anionic group may be used. Examples of the dye include azo dyes, triphenylmethane dyes, (aza)phthalocyanine dyes, xanthene dyes, and anthrapyridone dyes. These dyes may be used singly or in combination.

### Resin Particles

The inks used in the embodiment disclosed herein may contain resin particles. The resin particles need not contain a coloring material. Some types of resin particles have an effect to improve image quality and fixability, and such resin particles are useful.

The material of the resin particles may be selected from among known resins without particular limitation. The resin particles may be made of an olefin resin, a styrene resin, an acrylic resin, or the like. The weight average molecular weight (Mw) of the resin particles may be in the range of 1,000 to 2,000,000. The volume average particle size of the resin particles measured by dynamic light scattering may be 10 nm to 1,000 nm, for example, 100 nm to 500 nm. The content of the resin particles in the ink may be 1.0% by mass to 50.0% by mass, for example, 2.0% by mass to 40.0% by mass, relative to the total mass of the ink.

### Aqueous Medium

The inks used in the embodiment disclosed herein may contain water or an aqueous medium that is a mixture of water and a water-soluble organic solvent. The water may be deionized water or ion exchanged water. The water content in the ink (aqueous ink) containing an aqueous medium may be 50.0% by mass to 95.0% by mass relative to the total mass of the ink. The water-soluble organic solvent content in the aqueous ink may be 3.0% by mass to 50.0% by mass relative to the total mass of the ink. The water-soluble organic solvent may be any of the water-soluble organic solvents used in ink jet inks including alcohols, (poly)alkylene glycols, glycol ethers, nitrogen-containing compounds, and sulfur-containing compounds. These organic solvents may be used in singly or in combination.

### Other Constituents

The inks used in the present embodiment may optionally contain other constituents, such as an antifoaming agent, a surfactant, a pH adjuster, a viscosity modifier, a rust preventive, a preservative, a fungicide, an antioxidant, an antireductant, and a water-soluble resin.

### Auxiliary Liquid

The auxiliary liquid is a liquid operable to facilitate transfer and containing a thermoplastic resin that will act as a binder in and over the ink image. The auxiliary liquid is applied onto a primary image on the transfer member to form a secondary image. Thus, the transferability of the image to the printing medium is increased. The auxiliary liquid may be aqueous or nonaqueous. The thermoplastic resin may be at least either a water-soluble thermoplastic resin or a water-insoluble thermoplastic resin, depending on the type of the auxiliary liquid.

The thermoplastic resin used in the auxiliary liquid is not particularly limited provided that the resin can act as a binder having an intended function. The thermoplastic resin may be varied depending on the type of the auxiliary liquid application device. For example, when the auxiliary liquid application device is an ink jet device, a thermoplastic resin having a weight average molecular weight in the range of 2000 to 20000 may be used. In some embodiments using an ink jet auxiliary liquid application device, the weight average molecular weight of the thermoplastic resin may be in the range of 5000 to 10000.

The auxiliary liquid application device may be any other application device apart from the ink jet device, such as a roller coater device. If a roll coater device is used, a thermoplastic resin having a larger weight average molecular weight may be used.

The thermoplastic resin may have a glass transition temperature (Tg) of 40° C. to 150° C. If a transfer temperature is set depending on softening point or melting point of the resin, a thermoplastic resin having a softening point or melting point in the range of 40° C. to 150° C. may be used.

Examples of the water-soluble thermoplastic resin include block copolymers, random copolymers, and graft copolymer synthesized from at least two monomers (at least one of the monomers is a polymerizable hydrophilic monomer) selected from the group consisting of styrene, styrene derivatives, vinyl naphthalene, vinyl naphthalene derivatives, aliphatic alcohol esters of α,β-ethylenic unsaturated carboxylic acids, acrylic acid, acrylic acid derivatives, maleic acid, maleic acid derivatives, itaconic acid, itaconic acid derivatives, fumaric acid, fumaric acid derivatives, vinyl acetate, vinyl alcohols, vinyl pyrrolidone, acrylamide, and derivatives thereof, and salts of these copolymers.

These water-soluble thermoplastic resin resins are soluble in alkaline solutions prepared by dissolving a base in water. In at least some embodiments, the water-soluble thermoplastic resin has a hydrophobic portion. The hydrophobic portion may have, but not limited to, a functional group having an unsaturated bond, such as a styrene group.

The thermoplastic resin may be a thermoplastic natural resin, such as rosin or shellac, or a resin derived from a natural substance such as modified starch.

One or more of the thermoplastic resins cited above may be used as a binder in the auxiliary liquid.

In some embodiments, the auxiliary liquid may contain wax particles. The wax particles may be solid at room temperature and have a melting point.

By applying the auxiliary liquid containing a thermoplastic resin and wax particles onto the ink image, followed by heating, the transferability of the ink image to the printing medium having a coating layer (ink-receiving layer) is significantly increased. The reason of this is probably because the adhesion between the wax particles and the coating layer of the printing medium is high. This helps enhance the effect produced by controlling the amount of auxiliary liquid to be applied and the area to which the auxiliary liquid is applied. It is therefore beneficial to add wax particles into the auxiliary liquid.

The melting point (Tm) of the wax particles may be 40° C. to 150° C.

The wax component in the wax particles may be, for example, natural wax or synthesized wax.

Examples of the natural wax include petroleum waxes, plant waxes, and animal waxes.

Exemplary petroleum waxes include paraffin wax, microcrystalline wax, and petrolatum. Exemplary plant waxes include carnauba wax, candelilla wax, rice wax, and Japan tallow. Exemplary animal waxes include lanolin and beeswax.

Examples of the synthesized wax include synthesized hydrocarbon waxes and modified waxes.

Exemplary synthesized hydrocarbon waxes include polyethylene wax and Fischer-Tropsch wax. Exemplary modified waxes include paraffin wax derivatives, montan wax derivatives, and microcrystalline wax derivatives.

The waxes cited above may be used singly or in combination.

The wax particles may be used in the form of a dispersion in which the wax particles are dispersed in a liquid when the auxiliary liquid is prepared. The wax particles may be formed by dispersing the material of wax with a dispersant. The dispersant may be, but is not limited to, a known dispersant. It is beneficial to select a dispersant in view of the stability of the dispersion of wax particles in the auxiliary liquid. The water-soluble resin described above as a binder may be used as the dispersant to disperse the wax particles.

The volume average particle size of the wax particles may be 10 nm to 1000 nm, for example, 50 nm to 500 nm, from the viewpoint of increasing transfer efficiency. Wax particles having a volume average particle size in this range are easily retained on the ink image. Thus, when the ink image is transferred, probably, a much larger amount of wax particles fills the gap between the ink image and the coating layer of the printing medium, thereby increasing the transferability of the ink image.

The thermoplastic resin content in the auxiliary liquid may be in the range of 0.1% by mass to 20% by mass relative to the total mass of the auxiliary liquid. In some embodiments, the thermoplastic resin content may be in the range of 0.1% by mass to 10% by mass, for example, 0.1% by mass to 5% by mass, relative to the total mass of the auxiliary liquid. When the thermoplastic resin content is in such a range, the ejection performance of the auxiliary liquid from the ink jet auxiliary liquid application device can be improved in terms of, for example, ejection stability and accuracy of landing positions. Also, the uniformity of the coating, when the auxiliary liquid is applied by roller coating, is increased.

The wax particle content may be in the range of 0.5% by mass to 20% by mass, for example, 1% by mass to 10% by mass, relative to the total mass of the auxiliary liquid. The mass ratio of the thermoplastic resin to the wax particles in the auxiliary liquid may be in the range of 3:1 to 1:10, for example, 1:1 to 1:10.

In at least some embodiments, the auxiliary liquid may contain resin particles. The same resin particles as the resin particles used in the ink described above may be used in the auxiliary liquid. The use of resin particles in the auxiliary liquid suppresses a movement of the ink image (secondary image) on the transfer member and enhances the fastness of the image on the printing medium. Also, the resin particles increase the strength of the coating of the auxiliary liquid, thus increasing the transferability.

The mass ratio of the resin particles to the wax particles may be in the range of 10:1 to 1:20, for example, 5:1 to 1:10. When the mass ratio of the resin particles to the wax particles is in such a range, the resin particles can function effectively.

In some embodiments, the surface tension of the auxiliary liquid may be lower than that of the ink. Such an auxiliary liquid can spread over the transfer member and accordingly come easily into contact with the ink.

The glass transition temperature Tg of the resin particles may be 30° C. to 150° C.

The auxiliary liquid may further contain other constituents that can be used in the ink as additives, such additive includes a surfactant, a water-soluble organic solvent, an adjusting agent, a rust preventive, a preservative, a fungicide, an antioxidant, an antireductant, a water-soluble resin and its neutralizer, and a viscosity modifier.

When the auxiliary liquid is aqueous, the liquid medium of the auxiliary liquid may be water or a mixture of water and a water-soluble organic solvent. The water may be deionized water or ion exchanged water. The water content in the aqueous auxiliary liquid may be 60% by mass to 98% by mass relative to the total mass of the auxiliary liquid. The content of the water-soluble organic solvent in the aqueous auxiliary liquid may be 2% by mass to 40% by mass relative to the total mass of the auxiliary liquid. The water-soluble organic solvent may be any of those used in ink jet inks, and examples thereof include alcohols, (poly)alkylene glycols, glycol ethers, nitrogen-containing compounds, and sulfur-containing compounds. These organic solvents may be used in singly or in combination.

When the auxiliary liquid is not aqueous, a known organic solvent may be used as the liquid medium of the auxiliary liquid. For example, an alcohol-based organic solvent, such as methanol or ethanol, may be used.

In at least some embodiments, the auxiliary liquid may be applied onto the image forming surface of the transfer member so as to cover the area of the ink with a larger area of the auxiliary liquid. Thus, the ink image can be stably transferred even if the landing positions of the ink droplets deviate.

### Measurement of Melting Point of Wax Particles

The melting point of the wax particles may be measured in accordance with the temperature measurement specified in ASTM D3418. More specifically, the melting point of the wax particles may be taken as the peak top value of the highest melting temperature measured at a heating rate of 10° C./min in accordance with ASTM D3418 with DSC-7 (manufactured by PerkinElmer).

### Liquid Removal Device

The liquid removal device 105 used in the embodiment disclosed herein includes a liquid absorption member 105a and a pressing member 105b for liquid absorption operable to press the liquid absorption member 105a against the ink image on the member 101. The shapes of the liquid absorption member 105a and the pressing member 105b are not particularly limited. For example, a pillar-shaped pressing member 105b and a belt-like liquid absorption member 105a may operate in such a manner that the pillar-shaped pressing member 105b presses the belt-like liquid absorption member 105a against the transfer member 101, as shown in FIG. 1. Alternatively, a pillar-shaped pressing member 105b and a hollow cylindrical liquid absorption member 105a disposed around the periphery of the pillar-shaped pressing member 105b may operate in such a manner that the pillar-shaped pressing member 105b presses the hollow cylindrical liquid absorption member 105a against the transfer member 101.

In at least some embodiments, the liquid absorption member 105a may be a belt in view of the space or the like in the transfer ink jet printing apparatus.

The liquid removal device 105 including the belt-like liquid absorption member 105a may further include a stretching member operable to stretch the liquid absorption member 105a. The members designated by 105c in FIG. 1 are stretching rollers acting as the stretching member. In FIG. 1, the pressing member 105b may be a rotatable roller as with the stretching rollers.

The liquid removal device 105 reduces the liquid content in the ink image in such a manner that the pressing member 105b presses the liquid absorption member 105a against the ink image to bring them into contact so that liquid absorption member 105a can absorb liquid from the ink image.

As an alternative to this method for removing liquid from the ink image, the liquid in the ink image may be removed by, for example, heating, blowing with low-humidity air, or reducing pressure. At least one of these methods may be used in addition to another ink removal. For example, after the liquid content is reduced by the above-described ink removal performed by bringing the liquid absorption member into contact with the ink image, the liquid content may be further reduced by heating.

### Liquid Absorption Member

In the embodiment disclosed herein, at least a portion of the liquid in the ink image is removed by bringing the absorption member including a porous portion into contact with the ink image for absorption. The liquid absorption member has a first side that is the surface to come into contact with the ink image. The porous portion is disposed on the first side. The liquid absorption member including such a porous portion may be in a form operable to circulate in cooperation with the movement of the surface of the transfer member for liquid absorption so as to come into contact with the ink image and further come into contact periodically with another ink image from which liquid will be removed. In some embodiments, such a liquid absorption member may be in the form of an endless belt or a drum.

### Porous Portion

The porous portion of the liquid absorption member may be such that the average pore size on the first side is smaller than that on the second side opposite the first side. From the viewpoint of reducing attachment of the coloring material in the ink to the porous portion, a small pore size is beneficial. At least some embodiments, the average pore size of the porous portion on the first side, which is to come into contact with the ink image, may be 10 μm or less. The average pore size mentioned herein refers to the average diameter of the pores in the surface on the first side or the surface on the second side and can be measured by, for example, a known method, such as mercury intrusion, nitrogen adsorption, or SEM image observation.

From the viewpoint of ensuring a high breathability, the thickness of the porous portion may be small. The breathability may be represented by the Gurley value specified in JIS P8117, and a Gurley vale of 10 s or less is beneficial.

However, the porous portion having a small thickness may not have a volume sufficient to absorb liquid. Accordingly, a multilayer porous portion may be beneficial. The layers of the liquid absorption member, not coming into contact with the ink image are not necessarily porous provided that the layer coming into contact with the ink image is the porous portion.

Thus, an ink image with a reduced liquid content, from which liquid has been removed is formed on the transfer member 101. The ink image after liquid removal is then transferred onto a printing medium 108 with the transfer unit. Devices or members and conditions for transfer will now be described.

### Pressing Member for Transfer

In the embodiment disclosed herein, the pressing member 106 for transfer brings the ink image on the transfer member 101, subjected to liquid removal into contact with a printing medium 108 conveyed by a printing medium conveying device 107, thus transferring the ink image onto the printing medium 108. The transfer unit used in the embodiment disclosed herein includes the pressing member 106 for transfer and the support member 102 of the transfer member 101. For transfer using the transfer unit, the ink image that is the secondary image on the transfer member is brought into contact with the printing medium and is then removed from the transfer member while being kept in contact with the printing medium. The ink image is thus transferred onto the printing medium.

By transferring the ink image on the transfer member 101 onto the printing medium 108 after removing liquid from the ink image, curling and cockling of the resulting printed article are reduced. The pressing member 106 has a structural strength to some extent from the viewpoint of durability and accuracy of conveying the printing medium 108. The pressing member 106 may be made of metal, ceramic, resin, or the like. Exemplary materials often used for the pressing member include aluminum, iron, stainless steel, acetal resin, epoxy resin, polyimide, polyethylene, polyethylene terephthalate, nylon, polyurethane, silica ceramics, and alumina ceramics. These materials are beneficial in terms of rigidity of the support member against pressure applied for transfer and dimensional accuracy and are also useful to reduce inertia during operation to improve control response. Two or more of these materials may be used in combination.

How long the pressing member 106 presses the transfer member 101 to transfer the ink image subjected to liquid removal onto the printing medium 108 is not particularly limited. The pressing time may be 5 ms to 100 ms from the viewpoint of successful transfer and maintaining the durability of the transfer member. The pressing time mentioned herein refers to the period of time for which the printing medium 108 is in contact with the transfer member 101 and is obtained by surface pressure measurement using a surface pressure distribution measurement system I-SCAN manufactured by NITTA and defined by the quotient of the length of the pressed region in the conveyance direction divided by the conveyance speed.

The pressure at which the pressing member 106 presses the transfer member 101 for transfer of the ink image subjected to liquid removal onto the printing medium 108 is not particularly limited, but the pressure is such a level as the ink image can be successfully transferred while maintaining the durability of the transfer member 101. In some embodiments, the pressure may be 9.8 N/cm² (1 kg/cm²) to 294.2 N/cm² (30 kg/cm²). The pressure mentioned herein refers to the pressure at the nip between the printing medium 108 and the transfer member 101 and is obtained by surface pressure measurement using a surface pressure distribution measurement system and defined by the quotient of the load on the pressed region divided by area.

The temperature at which the pressing member 106 presses the transfer member 101 for transfer of the ink image subjected to liquid removal onto the printing medium 108 is set depending on the temperature properties of the thermoplastic resin and wax in the auxiliary liquid and the temperature properties of the resin in the ink if the ink contains a resin component. For example, the temperature may be set at a temperature higher than or equal to the glass transition temperature, the softening point, or the melting point of the thermoplastic resin in the auxiliary liquid, or, if a wax is use, at a temperature higher than or equal to the melting point of the wax. If the ink contains a resin having a glass transition temperature or a softening point, the temperature may be selected so as to achieve desired transfer performance, taking into account the glass transition temperature or softening point or higher temperature.

Also, a heating device may be used to heat the ink image on the transfer member 101, the transfer member 101, and the printing medium 108. The heating device may be a hot-air blower operable to produce a current of hot air, an infrared heater operable to heat an object with infrared radiation, or any other known heating device. The infrared heater exhibits a high energy efficiency and is therefore beneficial.

The pressing member used for transfer may have any shape without particular limitation and may be in the form of a roller like the pressing member 106 shown in FIG. 1.

### Printing Medium and Printing Medium Conveyance Device

In the present disclosure, the printing medium 108 is not particularly limited, and any of the known printing media may be used. The printing medium may be, for example, an extra-long medium in the form of a roll or a sheet cut to a predetermined size. The printing medium may be made of paper, plastics, wood, corrugated cardboard, metal, or the like.

In the embodiment shown in FIG. 1, the printing medium conveyance device 107 operable to convey the printing medium 108 includes a printing medium feed roller 107a and a printing medium take-up roller 107b. However, the printing medium conveyance device 107 may have any structure provided that it can convey the printing medium.

### Control System

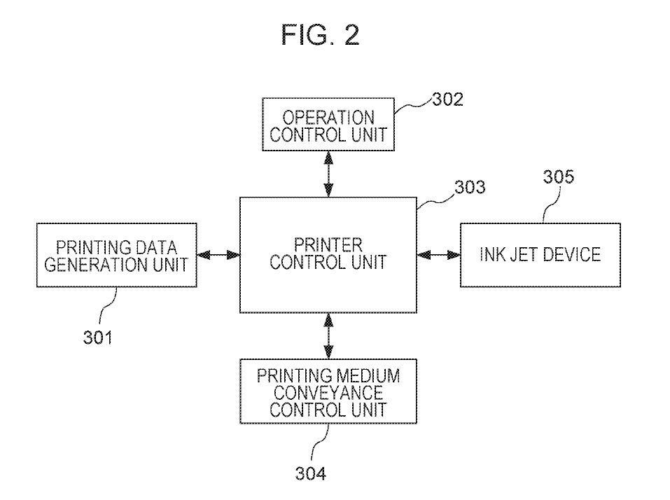

The transfer ink jet printing apparatus of the present disclosure includes a control system operable to control the devices and members of the apparatus. FIG. 2 is a block diagram of an overall control system of the transfer ink jet printing apparatus shown in FIG. 1.

In FIG. 2, reference numeral 301 designates a printing data generation unit, such as an external print server; reference numeral 302 designates an operation control unit, such as an operation panel; and reference numeral 303 designates a printer control unit operable to execute a printing process and a process for forming a transferability estimation pattern. Reference numeral 304 designates a printing medium conveyance control unit operable to convey printing media, and reference numeral 305 designates an ink jet device.

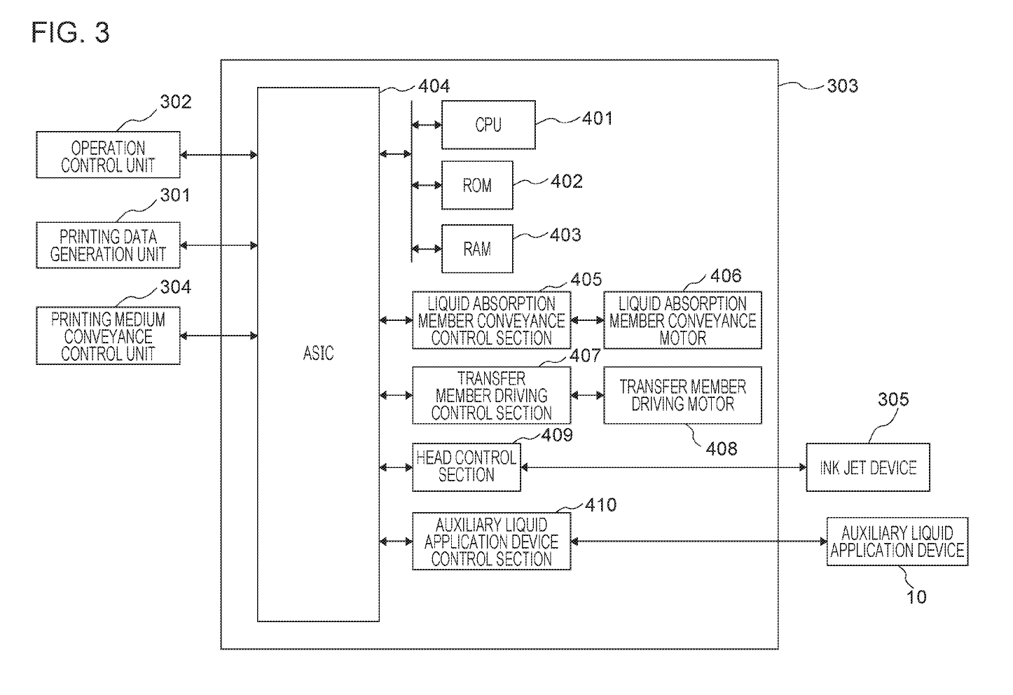

FIG. 3 is a block diagram of the printer control unit 303 of the transfer ink jet printing apparatus shown in FIG. 1.

Reference numeral 401 designates a CPU operable to control the entirety of the printing apparatus; reference numeral 402 designates a ROM device operable to store a control program for the CPU 401; and reference numeral 403 designates a RAM device operable to execute the program. Reference numeral 404 designates an application-specific integrated circuit (ASIC) containing a network controller, serial interface (serial IF) controller, a head data generation controller, and a motor controller. Reference numeral 405 designates a liquid absorption member conveyance control section that operates a liquid absorption member conveyance motor 406 and is controlled with commands from the ASIC 404 via the serial IF. Reference numeral 407 designates a transfer member driving control section that operates a transfer member driving motor 408 and is controlled with commands from the ASIC 404 via the serial IF. Reference numeral 409 designates a head control section operable to generate final ejection data and driving voltage for the ink jet device 305. Reference numeral 410 designates an auxiliary liquid application device control section operable to control the auxiliary liquid application device 10.

A control section for instruction to form a transferability estimation pattern and transfer the pattern onto the printing medium may be constituted of the CPU 401, the ROM 402, and the RAM 403 shown in FIG. 3. If transferability is automatically estimated from the transferability estimation pattern, this control section may control the automatic estimation device.

### Transferability Estimation Pattern

In the present disclosure, a transferability estimation pattern is formed, apart from the printing data (print pattern in an actual printing mode) inputted in the printing data generation unit 301 for forming a desired printed article.

The transferability estimation pattern includes a plurality of unit images each including an estimation ink image, and the unit images vary in amount of auxiliary liquid applied to the estimation ink image for estimation.

The transferability estimation images vary in amount of auxiliary liquid applied thereto, and the amount of applied auxiliary liquid is a reference for determining the degree of transfer performance. The amount of auxiliary liquid used as the reference may be the amount of auxiliary liquid applied for one pixel of the ink image.

In at least some embodiments, at least one of the plurality of estimation images of the transferability estimation pattern is a transfer failure prediction image used for prediction of transfer failure. The transfer failure prediction image may be an image formed with a smaller amount of auxiliary liquid than the amount of auxiliary liquid used in a mode for forming printed articles, for example, in the actual printing mode. In this instance, the amount of auxiliary liquid to be applied may be an amount of auxiliary liquid applied for one pixel of the ink image as mentioned above.

When the transferability estimation pattern includes the transfer failure prediction image, the occurrence of transfer failure is predicted before the failure occurs in the actual printing mode, and the transfer member can be replaced at an appropriate timing. Thus, transfer failure resulting from continuous use of a transfer member degraded in transfer performance in the actual printing mode can be prevented.

For varying the amount of auxiliary liquid applied to the estimation ink image among the unit images, it may be beneficial to vary the amount per area of auxiliary liquid applied to the auxiliary liquid-applied region on the image forming surface for one pixel of the estimation ink image. For varying the amount of auxiliary liquid as above, at least one of the following methods may be used:

(I) Varying the amount of auxiliary liquid by varying the amount of auxiliary liquid applied onto the estimation ink image among the unit images
(II) Varying the amount of auxiliary liquid by using unit images, each including an ink image and having an auxiliary liquid-applied region containing the ink image in plane on the image forming surface, the auxiliary liquid-applied region having a larger area than the area of the ink image, and varying the area of the auxiliary liquid-applied region among the unit images

Method (I) is a method to increase the thickness of a binder layer formed with the auxiliary liquid on the estimation ink image. This method is beneficial because the binder layer formed with the auxiliary liquid on a printing medium such as smooth paper is difficult to visually recognize.

Method (II) is a method to increase the area on the image forming surface to which the auxiliary liquid is applied. This method is beneficial from the viewpoint of reducing insufficient coating resulting from a variation in auxiliary liquid application speed or a variation in volume of the binder layer formed with the auxiliary liquid on the image forming surface.

If method (II) is solely used, it is beneficial, from the viewpoint of simply controlling the application conditions of the auxiliary liquid, to set constant the amount of auxiliary liquid applied for estimation for each unit area of the auxiliary liquid-applied region and to vary the area of the auxiliary liquid-applied region.

It is also beneficial to set constant among the unit images the amount of ink applied for forming the estimation ink image, from the viewpoint of increasing the accuracy of transferability estimation.

A plurality of transferability estimation patterns varying in amount of ink used for forming the estimation ink image may be used in combination.

In method (II), the auxiliary liquid-applied region may be a region on the image forming surface of the transfer member, defined (surrounded) by an outline and expanded outward from the outline of the estimation ink image.

By varying the amount of auxiliary liquid applied for estimation among the unit images, the minimum amount of auxiliary liquid required for successful transfer against a change in transferability resulting from deterioration of the transfer member and the like can be determined.

For example, repeated formation of printed articles may change transfer performance, increasing the threshold of the minimum amount of auxiliary liquid required for successful transfer. If this threshold increases to a value larger than the amount of auxiliary liquid used for forming printed articles while the user does not notice the change in transfer performance, transfer failure may occur while the apparatus operates and result in defects in printed articles, reducing productivity.

In contrast, in the case of printing a plurality of unit images on a printing medium by varying the amount of auxiliary liquid for estimation for each of the estimation ink images formed with the same amount of ink, when a transfer failure is detected in a unit image to which a smallest amount of auxiliary liquid has been applied, an amount of auxiliary liquid larger than this smallest amount may be used for estimation as the amount required for successful transfer. Thus, by printing a transferability estimation pattern on the printing medium and checking the transferred unit images, the user of the apparatus can estimate when the transfer member should be replaced or when the transfer unit should be maintained, depending on the changes in transfer performance. When it is considered that the time for replacement of the transfer member or the time for maintenance of the transfer unit approaches, the formation of a detective printed article is prevented to prevent a decrease in productivity of printed articles by the foregoing operation.

For estimating the minimum amount of auxiliary liquid to be applied, it is beneficial that the transferability estimation pattern include a unit image formed by applying a smaller amount of auxiliary liquid than the amount per area of auxiliary liquid applied to each pixel of the secondary image formed in an actual printing mode. This smaller amount of auxiliary liquid than the amount of auxiliary liquid in the actual printing mode may be set as the amount which allows the apparatus to operate continuously and at which transfer failure may occur if the operation of the apparatus continues. If a transfer failure occurs in the unit image formed by applying a smaller amount of auxiliary liquid than the amount of auxiliary liquid in the actual printing mode, such setting enables the detection of a possibility of transfer failure in case where the operation of the apparatus continues. Thus, measures for preventing transfer failure can be taken at an appropriate timing.

The transferability estimation pattern may be printed on the printing medium at regular intervals for checking the degree of transfer performance. The printing of the transferability estimation pattern on the printing medium may be performed by user input, if necessary, for checking the degree of transfer performance.

If the printing medium of a printed article has a margin, the transferability estimation pattern may be printed in this margin. In this instance, the printed article may be cut out to be separated from the portion on which the transferability estimation pattern is printed for intended use. The use of a margin may be applied to the case of using an extra-long printing medium or a printing medium in a sheet form.

When some sheets are used as the printing medium, the transferability estimation pattern may be printed at an appropriate timing between operations for printing printed articles in such a manner that one of the sheets is used exclusively for printing the transferability estimation pattern at regular intervals or as needed.

The transferability estimation pattern transferred onto the printing medium may be visually checked by the user for estimating transferability. In this instance, a reference of the transferability estimation pattern formed according to examination results may be prepared in advance so that the user can estimate transferability with respect to the reference.

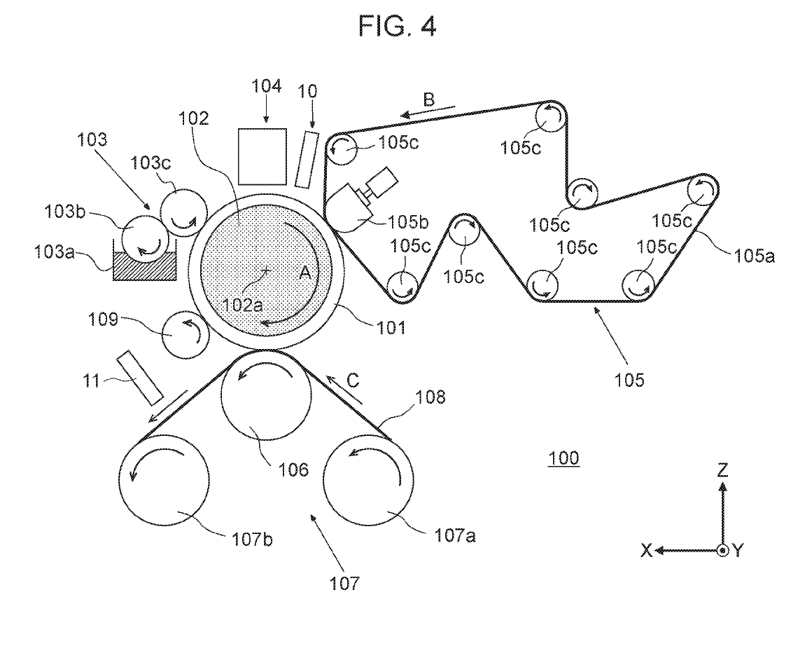

Alternatively, an automatic estimation device including an engineered automatic estimation unit, such as a scanner 11 or a camera, operable to scan the transferability estimation pattern on the printing medium may be disposed for automatic estimation at a position allowing the transferability estimation pattern to be detected, as shown in FIG. 4. Such automatic estimation facilitates efficiency of transferability estimation and is therefore beneficial for increasing the productivity of printed articles.

If at least a portion of the transferability estimation pattern remains on the image forming surface of the transfer member after transfer and before cleaning, the transferability may be estimated from the remaining pattern. The transferability may be estimated from both the portion of the transferability estimation pattern transferred onto the printing medium and the portion remaining on the image forming surface of the transfer member.

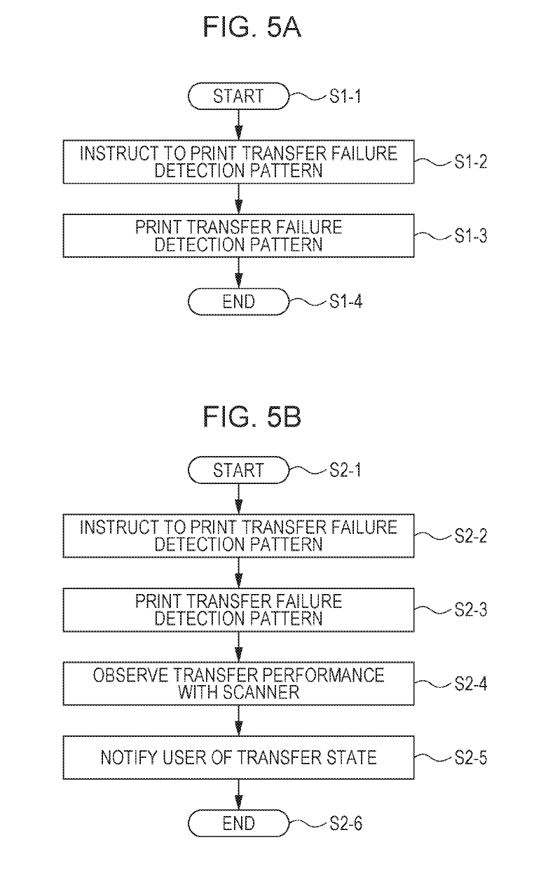

FIGS. 5A and 5B each show a process flow for printing a transferability estimation pattern functioning as a transfer failure detection pattern on a printing medium.

FIG. 5A is a process flow for visually estimating transferability. As shown in FIG. 5A, a user operates a control unit operable to instruct the apparatus to form a transfer failure detection pattern, thus starting the process (S1-1). Responding to this user operation, the control unit instructs the transfer member driving control section, a reaction liquid application device control section, the head control section, the auxiliary liquid application device control section, the liquid absorption member conveyance control section, the printing medium conveyance control unit, a transfer roller control section, or the like to print the transfer failure detection pattern on a printing medium (S1-2). The transfer failure detection pattern is printed on the printing medium according to the instruction from the control unit (S1-3), and thus the process is terminated at the time when the printing is completed (S1-4).

The transfer failure detection pattern printed on the printing medium is observed and compared with a reference state that is a standard for the estimation of transferability. Reference states used as estimation standards include, for example, a state exhibiting good transfer performance, a state exhibiting poor transfer performance but no transfer failure, a state exhibiting a high probability of transfer failure, and a state where a transfer failure has occurred. Information of the states of the transfer failure detection pattern printed in each of these states is given to the user, and the user compares the transferability estimation pattern printed on the printing medium with the information, thus determining the transfer performance. An instruction to replace the transfer member or maintain the transfer member unit may be attached in case where a state exhibiting a high probability of transfer failure is detected. This is useful to appropriately estimate when the transfer member or the transfer unit should be maintained.

When the portion of the transferability estimation pattern remaining on the transfer member is used, the same process as described above may be used.

FIG. 5B is a process flow for automatically estimating transferability. As shown in FIG. 5B, a user operates a control unit operable to instruct the apparatus to form a transfer failure detection pattern, thus starting the process (S2-1). Responding to this user operation, the control unit instructs the transfer member driving control section, a reaction liquid application device control section, the head control section, the auxiliary liquid application device control section, the liquid absorption member conveyance control section, the printing medium conveyance control unit, a transfer roller control section, or the like to print the transfer failure detection pattern on a printing medium (S2-2). The transfer failure detection pattern is printed on the printing medium according to the instruction from the control unit (S2-3). The transferability estimation pattern printed on the printing medium is captured as image information by the scanner for observing the transfer performance (S2-4). The user is notified of the result of transfer performance (S2-5), and the process is terminated (S2-6).

The image information of the transferability estimation pattern captured by the scanner is used to determine the degree of the transfer performance. How to determine the degree of transfer performance is not particularly limited, and the transfer performance may be determined according to a known determination scheme by comparing image information. For example, standard image information representing gradual changes of transfer performance according to a plurality of typical patterns for transferability estimation is stored, and the transferability estimation pattern printed on the printing medium is compared with the standard image information to determine what stage the transfer performance is in. A program for such determination may be stored in the control unit for automatically determining the degreed of transfer performance. Reference states providing standard image information include, for example, a state exhibiting good transfer performance, a state exhibiting poor transfer performance but no transfer failure, a state exhibiting a high probability of transfer failure, and a state where a transfer failure has occurred.

The user is notified of the degree of transfer performance with an image or a sound, according to the observation result of the transfer performance of the transferability estimation pattern printed on the printing medium. For example, when a state exhibiting a high probability of transfer failure is detected, the user is notified that the transfer member should be replaced or that the transfer unit should be maintained by a report printed on the printing medium or by a warning sound.

Also, when the transferability estimation pattern indicates a degradation in transfer performance, the user may be notified of the degree of deterioration and the timing of replacement. Alternatively, countermeasures against the degradation in transfer performance may be taken by a control to increase the amount of auxiliary liquid to be applied, increase transfer pressure, or increase transfer temperature.

The transferability estimation pattern may be printed automatically or according to instruction of the user at a timing the user desires the printing, or at a predetermined timing previously set by the manufacturer of the transfer ink jet printing apparatus or a selling agent.

The predetermined timing set by the manufacturer or selling agent of the apparatus may be set based on the information previously obtained according to the configuration or performance of the apparatus and information. For example, the timing at which a sign of occurrence of transfer failure can be detected may be set according to the elapsed time from the start of use at which the possibility of occurrence of transfer failure increases, the cumulative number of printed articles formed, or any other information.

The transferability estimation pattern may be printed according to an instruction from the user or an instruction from the user at a predetermined timing as described above, or may be automatically printed by a program previously installed in the control unit.

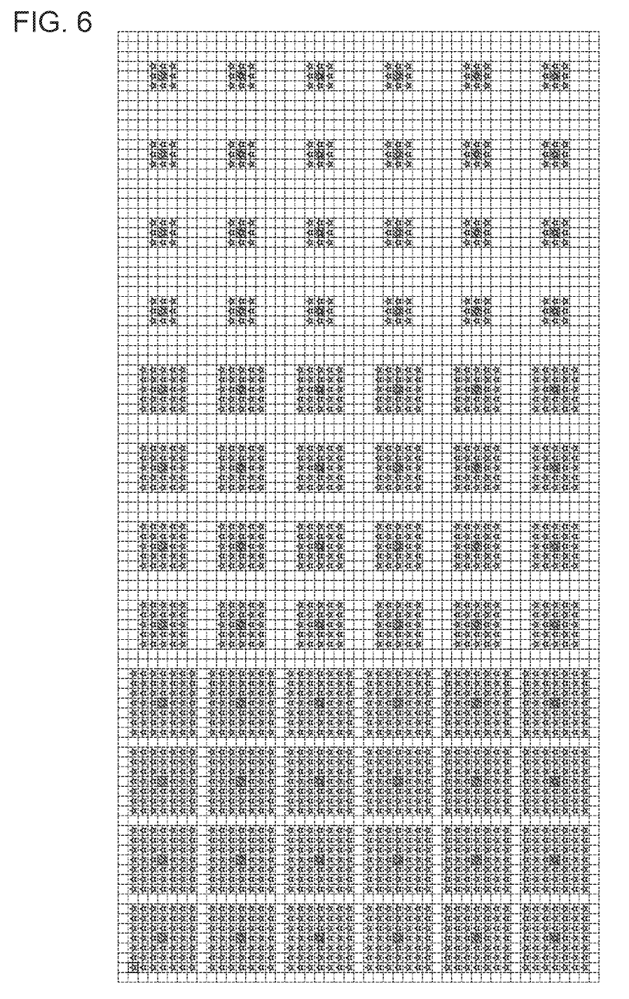

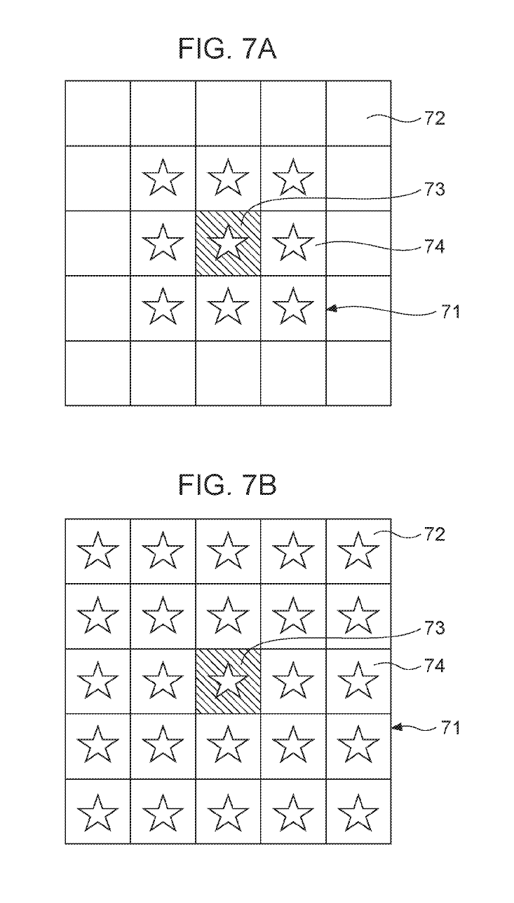

FIG. 6 and FIGS. 7A and 7B show exemplary transferability estimation patterns used in the foregoing method (II).

The squares defined by broken lines in FIG. 6 each represent a pixel that is a minimum unit at the image forming surface of the transfer member where ink dots are placed. The hatched pixels defined by solid lines each represent a region to which an ink is applied (hereinafter referred to as an ink-applied region). The pixels having a star are regions to which the auxiliary liquid is applied.

FIGS. 7A and 7B are enlarged views of two unit images in a transferability estimation pattern shown in FIG. 6, each showing a unit image to which a small amount of auxiliary liquid is applied. In FIGS. 7A and 7B, the squares representing pixels 72 are defined by solid lines.

A unit image 71 of the transferability estimation pattern has an ink-applied region 73 having an estimation ink image formed with an ink dot formed in a pixel; and an auxiliary liquid-applied region 74 to which the auxiliary liquid is applied, the auxiliary liquid-applied region including the ink-applied region 73 and a plurality of pixels spreading in plane around the ink-applied region 73 on the image forming surface.

In the unit image 71 shown in FIG. 7A, the auxiliary liquid applied for a pixel of the estimation ink image formed in the ink-applied region 73 is applied to the auxiliary liquid-applied region defined by 9 pixels. In the unit image 71 shown in FIG. 7B, the auxiliary liquid applied for a pixel of the estimation ink image formed in the ink-applied region 73 is applied to the auxiliary liquid-applied region defined by 25 pixels. In these unit images, the amount of ink forming the estimation ink image is set constant among unit images, and the amount of auxiliary liquid applied for each pixel is set constant. Under these conditions, only the amount of auxiliary liquid applied for the estimation ink image for estimation is varied by varying the area of the auxiliary liquid applied for each pixel of the estimation ink image.

By forming a transferability estimation pattern as a set of these unit images, the degree of transfer performance of the transfer member can be estimated by a single operation of transferring the transferability estimation pattern.

In FIG. 6, the ink images are each formed by the ink applied to one pixel. The amount per area of auxiliary liquid applied to each pixel is set constant, and the amount of auxiliary liquid applied for each unit image is varied by varying the number of pixels, that is, the area of the auxiliary liquid-applied region. In FIG. 6, patterns each defined by a series of unit images are arranged in 6 lines in parallel.

The form and arrangement of the unit images are not limited to those shown in FIG. 6 and may be varied so that transferability can be estimated as desired.

An image having an indicator or scale, not shown in FIG. 6, may be provided adjacent to the transferability estimation pattern. The indicator is used for comparison with the transferred image, thus helping the user to accurately determine when the transfer member should be replaced.

The indicator may be a form representing the remaining number of times of transfer for the transfer member or may be line images printed for each difference in amount of auxiliary liquid.

Transferability may vary depending on the material, such as paper, of the printing medium. Accordingly, it is beneficial that the amount of auxiliary liquid applied to the unit images for estimation be set according to the material of the printing medium. Thus, the amount of auxiliary liquid to be applied can be minimized. A physical property of the printing medium that can be used as a criterion for varying the amount of auxiliary liquid for forming unit images may be a surface roughness represented as Ra or Rz. When the printing medium has a low surface roughness, the amount of auxiliary liquid applied to unit images for estimation may be smaller than that when the printing medium has a high surface roughness.

### EXAMPLES

The subject matter of the present disclosure will be further described in detail with reference to Examples and Comparative Examples. The subject matter is however not limited to the following Examples. In the following Examples, “part(s)” is on a mass basis unless otherwise specified.

### Preparation of Reaction Liquid

The following constituents were mixed and sufficiently stirred, and the resulting mixture was subjected to pressure filtration through a cellulose acetate filter having a pore size of 3.0 μm (manufactured by Advantec) to yield a reaction liquid:
Levulinic acid: 40.0 parts
Glycerin: 5.0 parts
Megafac F444 (surfactant produced by DIC): 1.0 part
Ion-exchanged water: 54.0 parts

### Preparation of Resin Particles

A four-neck flask equipped with a stirrer, a reflux condenser, and a nitrogen gas-delivering device was charged with 18.0 parts of butyl methacrylate, 2.0 parts of polymerization initiator (2,2′-azobis(2-methylbutyronitrile)), and 2.0 parts of n-hexadecane. Subsequently, nitrogen gas was introduced to the reaction system, followed by stirring for 0.5 hour. Into this flask, 78.0 parts of 6.0% aqueous solution of an emulsifier NIKKOL BC15 (produced by Nikko Chemicals) was dropped, followed by stirring for 0.5 hour. Subsequently, the resulting mixture was subjected to supersonic wave irradiation for 3 hours to emulsify the mixture. The emulsified mixture then underwent a reaction at 80° C. for 4 hours in a nitrogen atmosphere. After the reaction system cooled to 25° C., the contents were subjected to filtration. An appropriate amount of pure water was added to the reaction product, thus preparing a dispersion of resin particles 1 in water containing 20.0% of resin particles 1 (solids).

### Preparation of Resin Aqueous Solution

A styrene-ethyl acrylate-acrylic acid copolymer (resin 1) having an acid value of 150 mg KOH/g and a weight average molecular weight of 8,000 was prepared. Resin 1 (20.0 parts) was neutralized with an amount of potassium hydroxide equivalent to the acid value of the resin, and an appropriate amount of pure water was added to yield an aqueous solution containing 20.0% of resin 1 (solids).

Also, a styrene-butyl acrylate-acrylic acid copolymer (resin 2) having an acid value of 132 mg KOH/g, a weight average molecular weight of 7,700, and a glass transition temperature of 78° C. was prepared, and an aqueous solution containing 20.0% of resin 2 (solids) was prepared in the same manner as the aqueous solution of resin 1, except for using resin 2.

### Preparation of Inks

### Preparation of Pigment Dispersion Liquid

A mixture of 10.0 parts of pigment (carbon black), 15.0 parts of resin 1, and 75.0 parts of pure water was prepared. The resulting mixture and 200 parts of zirconia beads of 0.3 mm in diameter were placed into a batch-type vertical sand mill (manufacture by Aimex) and agitated for 5 hours while being cooled with water. Then, after course particles were removed by centrifugation, the mixture was subjected to pressure filtration through a cellulose acetate filter having a pore size of 3.0 μm (manufactured by Advantec) to yield pigment dispersion liquid K containing 10.0% of pigment and 3.0% of resin dispersant (resin 1).

### Preparation of Ink

The following constituents were mixed and sufficiently stirred, and the resulting mixture was subjected to pressure filtration through a cellulose acetate filter having a pore size of 3.0 μm (manufactured by Advantec) to yield an ink:
Pigment dispersion liquid K: 20.0% by mass
Dispersion of resin particles 1 in water: 50.0% by mass
Resin 1 aqueous solution: 5.0% by mass
Glycerin: 5.0% by mass
Diethylene glycol: 7.0% by mass
Acetylenol E 100 (surfactant, produced by Kawaken Fine Chemical): 0.5% by mass
Pure water: 12.5% by mass

### Preparation of Auxiliary Liquid

The following constituents were mixed and sufficiently stirred, and the resulting mixture was subjected to pressure filtration through a cellulose acetate filter having a pore size of 3.0 μm (manufactured by Advantec) to yield an auxiliary liquid:
Dispersion of resin particles 1 in water: 30.0% by mass
Resin 2 aqueous solution: 3.0% by mass
Glycerin: 5.0% by mass
Diethylene glycol: 4.0% by mass
Acetylenol E 100 (surfactant, produced by Kawaken Fine Chemical): 1.0% by mass
Ion-exchanged water: 57.0% by mass

### Porous Portion

A polytetrafluoroethylene (PTFE) porous film having an average pore size of 0.4 μm heat-laminated with nonwoven fabric HOP (manufactured by Hirose Paper Mfg) was prepared as the liquid absorption member 105a. This liquid absorption member 105a had a Gurley vale of 5 s.

Ink Jet printing Apparatus and Image Formation

The transfer ink jet printing apparatus shown in FIG. 1 or FIG. 4 was used. The transfer member 101 was secured to the surface of the support member 102 with a double-sided adhesive tape. A sheet prepared by coating a 0.5 mm polyethylene terephthalate (PET) sheet with a 0.3 mm-thick silicone rubber KE12 (produced by Shin-Etsu Chemical) was used as the elastic layer of the transfer member 101. Furthermore, a mixture of glycidoxypropyltriethoxysilane and methyltriethoxysilane with a mole ratio of 1:1 was heated to reflux to yield a condensate, and the condensate was mixed with a photo cationic polymerization initiator SP150 (produced by ADEKA). The elastic layer was subjected to treatment with an atmospheric pressure plasma so that the contact angle of water on the surface of the elastic layer could be 10 degrees or less. Then, the above-prepared mixture was applied onto the elastic layer, and the coating was irradiated with UV radiation (high-pressure mercury-vapor lamp, integrated exposure dose: 5000 mJ/cm²) and cured by heat (150° C., 2 hours). Thus, a transfer member 101 was produced, having a 0.5 μm-thick surface layer formed on the elastic layer. The surface of the transfer member 101 was kept at 60° C. by a heating device not shown.

The amount of reaction liquid applied from the reaction liquid application device 103 was set at 0.5 g/m². an ink jet head operable to eject ink on demand with electrothermal conversion elements was used as the ink application device 104 to form a solid image on the transfer member. In this image formation, the solid image was printed by applying 4 pL of ink and auxiliary liquid each for each dot.

The liquid absorption member 105a has a porous portion on the side that is to come into contact with the first image. The liquid absorption member 105a was soaked with a wetting liquid containing 95 parts of ethanol and 5 parts of water, and the wetting liquid was substituted by water before use. The pressure at the nip between the transfer member 101 and the absorption member 105a was controlled at 3 kg/cm² in average by a pressure of the pressing member 105b. The pressing member 105b for liquid absorption had a diameter of 250 mm. At least a portion of the aqueous liquid absorbed by the porous portion in contact with the first image was removed from the porous portion before coming into contact with the first image again.

The conveyance speed of the liquid absorption member 105a was adjusted, by the stretching rollers 105c operable to stretch and convey the liquid absorption member 105a, to be the same as the speed at which the surface of the transfer member 101 moved. Also, the printing medium 108 was conveyed at a speed controlled to be the same as the speed at which the surface of the transfer member 101 moved, by the feed roller 107a and the take-up roller 107b. The printing medium 108 was conveyed at a speed of 0.15 m/s.

### Example 1

Printing was performed on the image forming surface in the transfer ink jet printing apparatus shown in FIG. 1 under the following conditions by switching between the actual printing mode and the transferability estimation pattern forming mode.

In the actual printing mode, a secondary image was formed by applying the auxiliary liquid onto the image forming surface of the transfer member 101 so that the area of the auxiliary liquid spread by two dots in every direction for one dot of the ink forming an ink image, as shown in FIG. 7B. In other words, for one dot of the ink, the auxiliary liquid was applied to a region (auxiliary liquid-applied region) of 5 dots by 5 dots.

Furthermore, for an ink image formed with 2 dots by 2 dots, the auxiliary liquid was applied to an auxiliary liquid-applied region of 6 dots by 6 dots.

OK Prince High Quality Paper (with a basis weight of 127 g/m², manufacture by Oji Paper) was used as the printing medium 108.

In the transferability estimation pattern forming mode, two transferability estimation patterns were formed on the image forming surface of the transfer member 101 by printing dots of estimation ink images, one each at intervals of 20 dots and by applying the auxiliary liquid so that the area of the auxiliary liquid spread by two dots or three dots in every direction for one dot of each ink image. In other words, for one dot of the ink, the auxiliary liquid was applied to a region of 5 dots by 5 dots and to a region of 7 dots by 7 dots; and for 2 dots by 2 dots of the ink, the auxiliary liquid was applied to a region of 6 dots by 6 dots and a region of 8 dots by 8 dots.

### Comparative Example

Printing was performed in the same manner as in Example 1, except for using only the actual printing mode without printing the transferability estimation pattern, and it was determined by user's visual observation that a transfer failure would occur.

### Example 2

Printing was performed in the same manner as in Example 1, except that the density of the transferability estimation pattern transferred onto the printing medium was determined with the automatic scanner in the apparatus shown in FIG. 4.

### Example 3

In Example 1, the auxiliary liquid was applied so that the area of the auxiliary liquid spread by two dots in every direction for one dot of the ink in the actual printing mode. In contrast, in Example 3, two patterns were formed by printing ink dots, one each at intervals of 20 dots and by applying the auxiliary liquid so that the area of the auxiliary liquid spread by two dots or one dot in every direction for one dot of the ink. In other words, for one dot of the ink, the auxiliary liquid was applied to a region of 5 dots by 5 dots and to a region of 3 dots by 3 dots; and for 2 dots by 2 dots of the ink, the auxiliary liquid was applied to a region of 6 dots by 6 dots and a region of 4 dots by 4 dots.

### Example 4

Aurora Coat (with a basis weight of 104 g/m², manufacture by manufactured by Nippon Paper Industries) was used as the printing medium 108.

In the actual printing mode, a secondary image was formed by applying the auxiliary liquid onto the image forming surface of the transfer member 101 so that the area of the auxiliary liquid spread by one dot in every direction for one dot of the ink.

In the transferability estimation pattern forming mode, two transferability estimation patterns were formed on the image forming surface of the transfer member 101 by printing dots of ink images, one each at intervals of 20 dots and by applying the auxiliary liquid so that the area of the auxiliary liquid spread by one dot or zero dots in every direction for one dot of each ink image. In other words, when the auxiliary liquid-applied region was spread by one dot for one dot of the ink, the auxiliary liquid was applied to a region of 3 dots by 3 dots; when the auxiliary liquid-applied region was spread by zero dots for one dot of the ink, the auxiliary liquid was applied to the same region as the region of one dot of the ink.

### Evaluation

The ink jet printing method using the transfer ink jet printing apparatus was examined in the manners of Examples 1 to 4 and Comparative Example 1. The results are shown in Table 1. For the Examples and Comparative Examples, ratings A and B represent that the results were good, and rating C represents that the results were unacceptable.

### Productivity

The productivity in the ink jet printing method was examined. The results were rated according to the following criteria:

A: Good productivity

B: Productivity was slightly degraded but was at an acceptable level.

C: Productivity was greatly degraded.

### Amount of Auxiliary Liquid

The amount of auxiliary liquid applied by the above-described image formation was determined. The results were rated according to the following criteria:

A: A minimum amount of auxiliary liquid was applied.

B: The amount of auxiliary liquid applied was slightly increased, but the increase was at an acceptable level.

TABLE

| | Productivity | Amount of auxiliary liquid |
|---|---|---|
| Example 1 | B | B |
| Example 2 | A | B |
| Example 3 | A | B |
| Example 4 | A | A |
| Comparative Example | C | B |

The ink jet printing method and apparatus of the present disclosure enable the user to estimate when the transfer member deteriorates or when a transfer failure occurs, thus increasing the productivity of the transfer member.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-237043 filed Dec. 11, 2017, which is hereby incorporated by reference herein in its entirety.

What is claimed is:

1. An ink jet printing method comprising:
forming a primary image by applying an ink onto an image forming surface of a transfer member;
forming a secondary image by applying an auxiliary liquid containing a thermoplastic resin onto the primary image on the transfer member; and
transferring the secondary image on the transfer member onto a printing medium by bringing the secondary image into contact with the printing medium and then removing the secondary image from the transfer member in a state where the secondary image is kept in contact with the printing medium,
wherein the secondary image includes a pattern adapted to estimate transferability, and the pattern includes a plurality of unit images, each including an estimation ink image formed with the ink and having an auxiliary liquid-applied region including the estimation ink image, the unit images varying in amount of the auxiliary liquid applied for the estimation ink image for estimation.

2. The ink jet printing method according to claim 1, wherein the amount of the auxiliary liquid applied to the auxiliary liquid-applied region on the image forming surface for one pixel of the estimation ink image is varied among the unit images.

3. The ink jet printing method according to claim 2, wherein the amount of the auxiliary liquid applied for estimation is varied by varying the amount of the auxiliary liquid applied onto the estimation ink image among the unit images.

4. The ink jet printing method according to claim 2, wherein the unit images each include an ink image and each have an auxiliary liquid-applied region including the ink image in plane on the image forming surface of the transfer member, the auxiliary liquid-applied region having a larger area than the area of the ink image, and wherein the amount of the auxiliary liquid applied for estimation is varied by varying the area of the auxiliary liquid-applied region among the unit images.

5. The ink jet printing method according to claim 2, wherein the unit images each include an ink image and each have an auxiliary liquid-applied region including the ink image in plane on the image forming surface of the transfer member, the auxiliary liquid-applied region having a larger area than the area of the ink image, and wherein the amount of the auxiliary liquid applied for estimation is varied by varying the area of the auxiliary liquid-applied region among the unit images, while the amount per unit area of the auxiliary liquid applied to the auxiliary liquid-applied region is set constant.

6. The ink jet printing method according to claim 2, wherein the plurality of unit images include a unit image formed by applying a smaller amount of the auxiliary liquid than the amount per area of the auxiliary liquid applied for one pixel of the secondary image.

7. The ink jet printing method according to claim 1, wherein the pattern is changed according to the type of the printing medium.

8. The ink jet printing method according to claim 1, further comprising automatically checking at least a portion of the pattern transferred onto the printing medium with a transferability estimation device.

9. The ink jet printing method according to claim 1, wherein the forming of the primary image includes applying a reaction liquid containing a constituent capable of increasing the viscosity of the ink onto the image forming surface.

10. The ink jet printing method according to claim 1, further comprising absorbing liquid from the secondary image by using a liquid absorption member.

11. An ink jet printing apparatus comprising:
an image forming unit including an ink application device operable to apply an ink onto an image forming surface of a transfer member to form a primary image;
an auxiliary liquid application device operable to apply an auxiliary liquid containing a thermoplastic resin onto the primary image on the transfer member to form a secondary image;
a transfer unit operable to bring the secondary image on the transfer member into contact with a printing medium and remove the secondary image from the transfer member in a state where the secondary image is kept in contact with the printing medium; and
a control unit operable to instruct the image forming unit and the auxiliary liquid application device to form a pattern adapted to estimate transferability on the image forming surface of the transfer member and instruct the transfer unit to transfer the pattern onto the printing medium,
wherein the pattern includes a plurality of unit images, each including an estimation ink image formed with the ink and having an auxiliary liquid-applied region including the estimation ink image, the unit images varying in amount of the auxiliary liquid applied for the estimation ink image for estimation.

12. The ink jet printing apparatus according to claim 11, wherein the amount of the auxiliary liquid applied to the auxiliary liquid-applied region on the image forming surface for one pixel of the estimation ink image is varied among the unit images.

13. The ink jet printing apparatus according to claim 12, wherein the amount of the auxiliary liquid applied for estimation is varied by varying the amount of the auxiliary liquid applied onto the estimation ink image among the unit images.

14. The ink jet printing apparatus according to claim 12, wherein the unit images each include an ink image and each have an auxiliary liquid-applied region including the ink image in plane on the image forming surface of the transfer member, the auxiliary liquid-applied region having a larger area than the area of the ink image, and wherein the amount of the auxiliary liquid applied for estimation is varied by varying the area of the auxiliary liquid-applied region among the unit images.

15. The ink jet printing apparatus according to claim 12, wherein the unit images each include an ink image and each have an auxiliary liquid-applied region including the ink image in plane on the image forming surface of the transfer member, the auxiliary liquid-applied region having a larger area than the area of the ink image, and wherein the amount of the auxiliary liquid applied for estimation is varied by varying the area of the auxiliary liquid-applied region among the unit images, while the amount per unit area of the auxiliary liquid applied to the auxiliary liquid-applied region is set constant.

16. The ink jet printing apparatus according to claim 12, wherein the plurality of unit images includes a unit image formed by applying a smaller amount of the auxiliary liquid than the amount per area of the auxiliary liquid applied for one pixel of the secondary image.

17. The ink jet printing apparatus according to claim 11, wherein the pattern is changed according to the type of the printing medium.

18. The ink jet printing apparatus according to claim 11, further comprising a transferability estimation device operable to automatically check at least a portion of the pattern transferred onto the printing medium.

19. The ink jet printing apparatus according to claim 11, wherein the image forming unit includes a reaction liquid application device operable to apply a reaction liquid containing a constituent capable of increasing the viscosity of the ink onto the image forming surface.

20. The ink jet printing apparatus according to claim 11, further comprising a liquid absorption member operable to absorb liquid from the secondary image.
